(19) United States
(12) Patent Application Publication
(10) Pub. No.: US 2026/0154260 A1
(43) Pub. Date: Jun. 4, 2026

(54) DECODER-ONLY EXTRACTIVE SCHEMA LINKING FOR TEXT-TO-SQL

(71) Applicant: INTERNATIONAL BUSINESS MACHINES CORPORATION, Armonk, NY (US)

(72) Inventors: Michael Robert Glass, Bayonne, NJ (US); Dharmashankar Subramanian, Rye Brook, NY (US); Long Vu, Chappaqua, NY (US); Gaetano Rossiello, Brooklyn, NY (US); Alfio Massimiliano Gliozzo, Brooklyn, NY (US)

(21) Appl. No.: 18/966,940

(22) Filed: Dec. 3, 2024

(51) Int. Cl. G06F 16/242; G06F 16/21

(52) U.S. Cl. CPC G06F 16/243; G06F 16/212

(57) ABSTRACT

Extractive schema linking includes generating a tokenized schema from an SQL schema, a tokenized natural language question, and tokenized candidates. The tokenized candidates are generated by tokenizing candidates from the SQL schema. Each tokenized candidate is formed by a string of tokens having a first token representing an initial delimiter and a last token representing an end delimiter. Vectorial representations of the tokenized schema, the tokenized natural language question, and tokenized candidates are generated, and transformed vectorial representations generated by processing the vectorial representations through a decoder-only model. Concatenated vectors are generated from the transformed vectorial representations of the tokenized candidates, the concatenated vectors generated by concatenating a first transformed vectorial representation corresponding to the first token with a last transformed vectorial representation corresponding to the last token of each tokenized candidate. Quantitative relevancies of the plurality of candidates from the SQL schema are generated based on the concatenated vectors.

### BACKGROUND

This disclosure relates to searching relational databases using the Structured Query Language (SQL) and, more particularly, to searching SQL databases using text-to-SQL queries.

Text-to-SQL technology refers to using natural language processing (NLP) to automatically generate SQL queries from natural language text. The automated generation of SQL queries is performed by converting a natural language question into an executable SQL SELECT statement that answers the question. The question operates over an SQL database schema that typically comprises tables, columns, column types, and primary and foreign key relationships. Schema linking is the automated process of detecting the tables and columns of a target SQL database that are relevant to the SQL query posed as a natural language question.

### SUMMARY

In one or more embodiments, a method of extractive schema linking includes generating a tokenized schema from an SQL schema, a tokenized natural language question, and tokenized candidates. The tokenized candidates are generated by tokenizing candidates from the SQL schema. Each tokenized candidate is formed by a string of tokens having a first token representing an initial delimiter and a last token representing an end delimiter. Vectorial representations of the tokenized schema, the tokenized natural language question, and tokenized candidates are generated. Transformed vectorial representations are generated by processing the vectorial representations through a decoder-only model. Concatenated vectors are generated from the transformed vectorial representations of the tokenized candidates. The concatenated vectors are generated by concatenating a first transformed vectorial representation corresponding to the first token with a last transformed vectorial representation corresponding to the last token of each tokenized candidate. Quantitative relevancies of the plurality of candidates from the SQL schema are generated based on the concatenated vectors.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example architecture of an extractive schema linking framework.

FIG. 2 illustrates an example method of operation of the extractive schema linking framework of FIG. 1.

FIGS. 3A and 3B illustrate an example SQL schema and related input to a decoder-only model implemented in the extractive schema linking framework of FIG. 1.

FIGS. 4A and 4B illustrate an example transformation performed by the decoder-only model implemented in the extractive schema linking framework of FIG. 1 and the output of a relevancy of each candidate with respect to answering a question posed in a text-to-SQL query.

FIG. 5 illustrates an example of a computing environment that is capable of implementing the decoder-only model implemented with framework of FIGS. 1 and 2.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to searching relational databases using the Structured Query Language (SQL) and, more particularly, to searching SQL databases using text-to-SQL queries.

In accordance with the inventive arrangements described herein, methods, systems, and computer program products are provided that are capable of determining the relevancy of multiple candidates for answering text-to-SQL queries posed as natural language questions. The candidates, in certain embodiments, may be table columns of an SQL schema. A candidate, in accordance with certain embodiments, is generated by enclosing a table name and corresponding table columns within a pair of special delimiter tokens. The special delimiter tokens are an initial delimiter token and an end delimiter token. The candidates are tokenized along with the schema and a natural language question. Vectorial representations of the tokenized schema, natural language question, and candidates are generated and input to a decoder-only model (DOM). In some embodiments the DOM leverages a known, pretrained decoder-only large language model (LLM) by providing the LLM with an SQL schema and implementing extractive schema linking for text-to-SQL searching of the schema. For each of the candidates, the DOM generates transformed vectorial representations of the tokenized schema, the natural language question, and the candidates. The transformed vectorial representations of the initial and end delimiters of each candidate are concatenated to form a concatenated vector for each candidate. The concatenated vectors are input to a linear layer, which outputs for each candidate a corresponding relevancy to the natural language question.

The quantitative relevancies may be represented as predicted probabilities. Each probability corresponds to the likelihood a table column of the SQL schema is relevant to the natural language question.

Among the technological advantages of the inventive arrangements over conventional technology is that the decoder-only model uses only the special delimiter tokens represented in a final concatenated vector for determining the relevance of each candidate. Unlike other schema linking approaches, extractive schema linking is capable of generating specific prediction probabilities that a candidate is relevant. Other schema linking techniques, such as generative schema linking, typically only indicate whether an object is more likely or not relevant to the natural language question. Such schema linking techniques provide only a binary assessment and do not rank objects relative to one another.

In certain embodiments, a prediction probability generated with extractive schema linking, as described herein, may be a log-probability corresponding to the likelihood a column of the SQL schema is relevant to the natural language question.

Another technological advantage refers to recall. Recall refers to a machine learning model's ability to accurately identify relevant objects. Extractive schema linking has a demonstrated high recall relative to other schema linking techniques in that extractive schema linking is more likely to identify all or most SQL table columns that are relevant to answering the natural language question. Other schema linking techniques typically have lower recall, meaning that at least some SQL table columns that are relevant to the natural language question are not identified.

A technological advantage of extractive schema linking over cross-encoder schema linking, for example, is a solution to the problem of SQL schemata that that are too large for the token windows typically used with cross-encoder schema linking. The inventive extractive schema linking described herein is capable of dealing with SQL schemata that exceed token limits of an LLM by effectively splitting the schema into segmented blocks and processing each block individually. For example, with a database schema that includes multiple tables, each table includes multiple columns. Each table, for example, is in the form of CREATE TABLE <table name> (column name1 column type 1, column name2 column type 2, . . . , column name N, column type N). First, the database schema is split into multiple sub-schemas, each having a set of CREATE TABLEs. That is, the database is split into multiple sub-databases, with each sub-database having a subset of tables. Each sub-database, then, is the input of the schema linker that finds the ranked list of columns relevant to answering the natural language question. The columns are ranked by a score produced by the LLM. By merging the ranked lists of columns of all sub-schemas, the most relevant columns (with highest scores) for answering the natural question are determined.

A technological advantage of extractive schema linking over graph neural networks is that extractive schema linking provides a foundational model—the DOM that may leverage known LLMs—for identifying SQL table columns relevant to a natural language question rather than merely relying on textual matching.

The DOM implemented with extractive schema linking, in certain embodiments, may be trained using a ground truth composed of relevant schema columns as targets. Training data used to train the DOM may be created using static analysis of the ground truth of SQL clauses (e.g., JOIN, WHERE, HAVING, GROUP BY, ORDER BY) for selecting the relevant schema columns.

In certain embodiments, the DOM is trained by iteratively revising the model to reduce a binary cross-entropy loss associated with output of the model in response to input of the training data.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

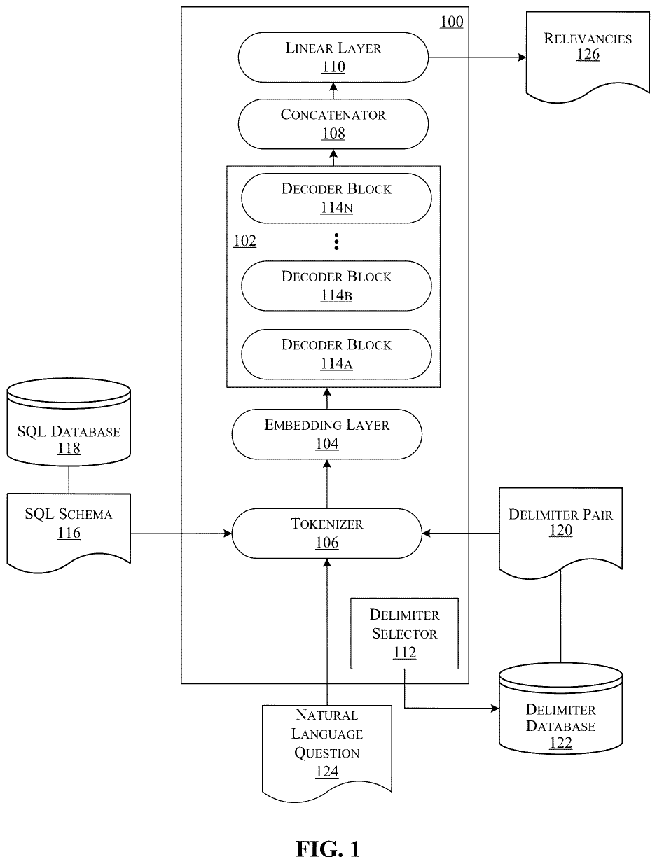

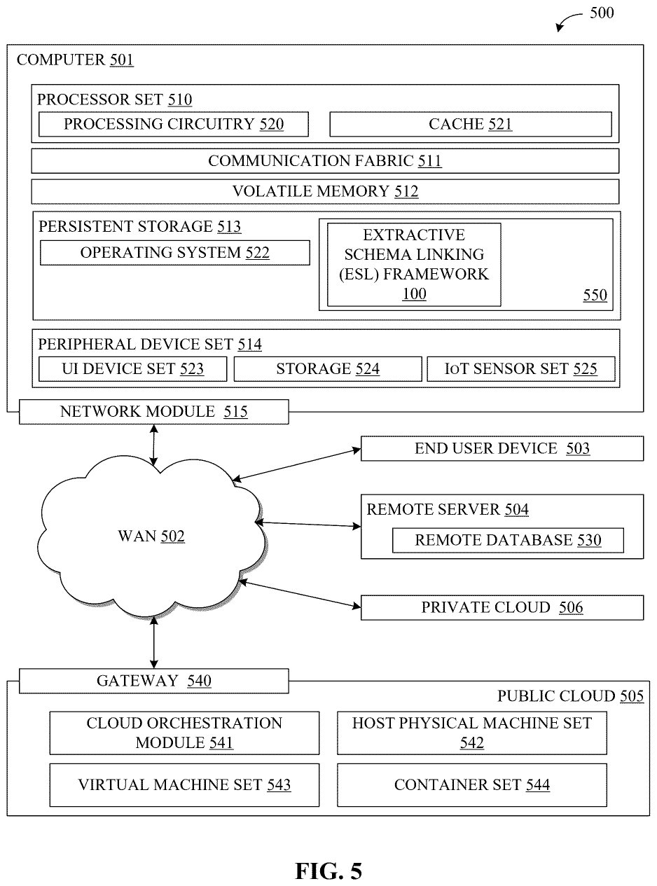

FIG. 1 illustrates an example architecture for extractive schema linking (ESL) framework 100. ESL framework 100 may be implemented in software that is executable on the hardware of a computer such as computer 501 operating in computing environment 500, as described in reference to FIG. 5.

In the example architecture of FIG. 1, ESL framework 100 illustratively includes decoder-only model (DOM) 102, embedding layer 104, tokenizer 106, concatenator 108, linear layer 110, and delimiter selector 112. DOM 102 illustratively includes decoder blocks 114a and 114b through 114n. The three decoder blocks shown are merely illustrative. Although in some embodiments there may be fewer in number, in most embodiments the n number of decoder blocks of DOM 102 likely will be considerably larger depending on the specific schema and text-to-SQL schema linking.

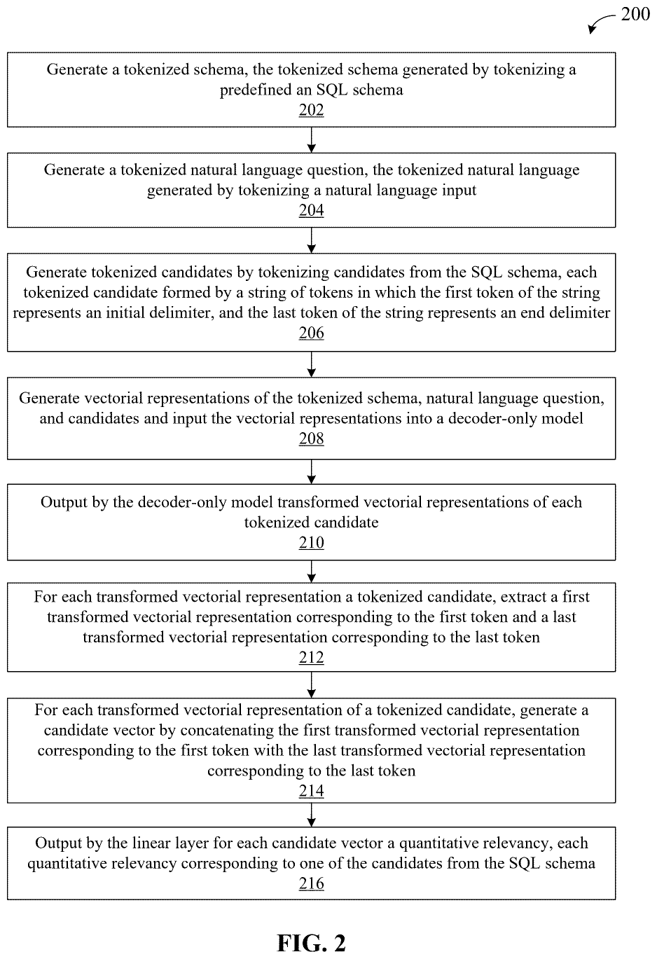

FIG. 2 illustrates an example method 200 of operation of the ESL framework 100 of FIG. 1. Referring jointly to FIGS. 1 and 2, in certain embodiments, in blocks 202 through 206, taken collectively, tokenizer 106 generates a tokenized schema from an SQL schema, a tokenized natural language question, and a plurality of tokenized candidates.

In block 202, specifically, tokenizer 106 generates the tokenized schema by tokenizing the content of SQL schema 116, which may be one of multiple schemata stored in SQL database 118.

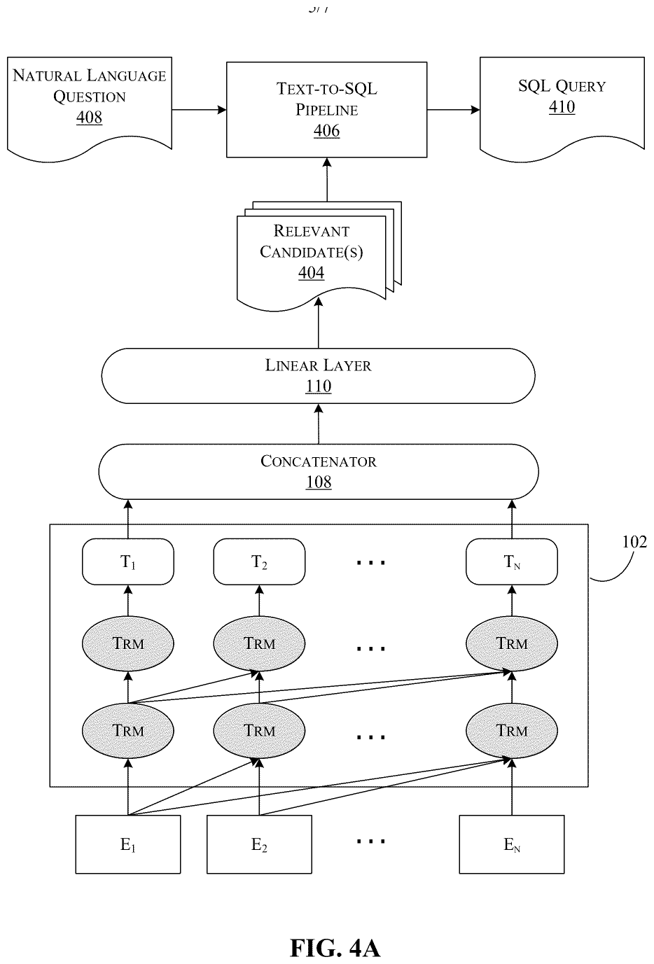

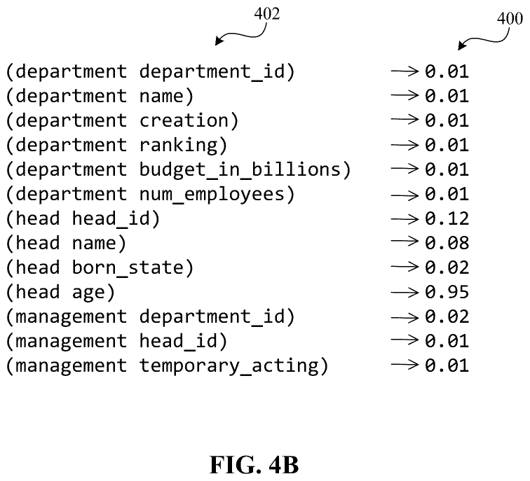

In block 204, tokenizer 106 generates the tokenized natural language question by tokenizing a natural language input (e.g., text or voice-to-text), namely natural language question 124. Natural language question 124 may be input to ESL framework 100 by a user and automatically tokenized by tokenizer 106. An illustrative and non-limiting example of natural language question 124 may be “How many heads of departments are over 56?” as discussed in greater detail hereinbelow in connection with FIG. 4A.

In block 206, tokenizer 106 generates multiple tokenized candidates. The tokenized candidates are generated by tokenizing a plurality of candidates from SQL schema 116. Each of the plurality of tokenized candidates is formed by a string of tokens having a first token representing an initial delimiter and a last token representing an end delimiter. The initial and end delimiters comprise delimiter pair 120.

The string of words that are enclosed by delimiter pair 120 are from SQL schema 116. In one or more embodiments, described below, the candidates are columns of the tables of SQL schema 116 and delimiter pair 120 encloses names of tables and the columns of each table of SQL schema 116. Delimiter pair 120 is automatically selected by delimiter selector 112 on a per-tokenizer basis from delimiter database 122. In various embodiments, depending on the specific tokenizer implemented by ESL framework 100, different delimiters may be automatically selected on the per-tokenizer basis. The characteristics of the different delimiters, however, are uniformly that each delimiter pair includes characters that are not valid SQL characters, are semantically like brackets, parentheses, or other such markers, and may each be represented by a single token. Each string of words enclosed within delimiter pair 120 is a candidate, each corresponding to a column of SQL schema 116. For example, each candidate may include a table name and a column name of the table. When tokenized, each word string (e.g., table name and name of one of the table's columns) enclosed within delimiter pair 120 forms a tokenized candidate.

In certain embodiments, each candidate is represented by the names of the tables and the names of each table's column(s). Each of the plurality of candidates from SQL schema 106 uniquely corresponds to a column of the SQL schema, and thus, there is a one-to-one relation between candidates and columns. That is, in certain embodiments, each of the schema's columns is a candidate both for training the model and during run time. The table and column names, exclusive of the individual rows, suffice to represent the candidates. It should be appreciated that while the tokenizing of candidates as described includes each candidate within a delimiter pair, delimiter pairs are not utilized in tokenizing the SQL schema or the natural language input.

In block 208, embedding layer 104 generates vectorial representations of the tokenized schema, tokenized natural language question, and each of the plurality of tokenized candidates. The tokens break out the SQL schema, the natural language question, and the candidates input to ESL framework 100 into distinct word tokens. For DOM 102 to operate on the input, each token is converted into vectors or so-called vector embeddings so that the matrix operations of DOM 102 may be performed. Each vector embedding is a mapping of each word token into a point in a vector space, which by pre-training with volumes of data results in the clustering of similar vectors and enables DOM 102 to perform the model's operations. As vectors (e.g., dense vectors) the vectorized representations of the tokenized schema, natural language question, and candidates have structures that can be manipulated by DOM 102. The vectorial representations of the tokenized schema, the tokenized natural language question, and the tokenized candidates are input to DOM 102.

In block 210, DOM 102 generates transformed vectorial representations by processing the vectorial representations through the decoder-only model. DOM 102 transforms the vectorial representations into transformed vectorial representation by passing the vectorial representations through sequentially stacked decoder blocks 114a-114n, each having an identical structure. The structure of each of decoder blocks 114a-114b may include masked, multi-head causal self-attention and feed-forward transformation sublayers for transforming the vectorial representations of the tokenized schema, natural language question, and candidates. Each feed-forward transformation sublayer passes each vectorial representation of the tokens through a feed-forward neural network, which includes two linear layers separated by a non-linear activation function. Self-attention is a feature that transforms each vectorial representation of a token based on the token's relationship to other tokens. Masking out tokens in a sequence prevents looking forward to subsequent tokens when looking at a currently attended token. Thus, masking out tokens implements causality by making the transformation of the attended token depend only on preceding tokens in the sequence and not succeeding ones. Implementing multi-head attention prevents one or a few tokens from dominating all the other tokens. In various other embodiments, decoder blocks 114a-114n may be structured using additional or different features for transforming the vectorial representations of the tokenized schema, natural language question, and candidates.

In blocks 212 and 214, taken collectively, concatenator 108 generates a plurality of concatenated vectors from each of the transformed vectorial representations of the tokenized candidates. Each concatenated vector is generated by concatenating a first transformed vectorial representation corresponding to the first token with a last transformed vectorial representation corresponding to the last token of the transformed vectorial representation.

In block 212, specifically, concatenator 108 extracts the first transformed vectorial representation corresponding to the first token and extracts the last transformed vectorial representation corresponding to the last token of the transformed vectorial representation of each transformed vectorial representation. Concatenator 108 performs the extraction for each transformed vectorial representation of the tokenized candidates. For each tokenized candidate, the first transformed vectorial representation of the candidate and the last transformed vectorial representation of the candidate are selected, and each intervening transformed vectorial representation of the candidate is excluded from the concatenating

In block 214, for each transformed vectorial representation of a tokenized candidate, concatenator 108 concatenates the first transformed vectorial representation corresponding to the first token with the last transformed vectorial representation corresponding to the last token of the tokenized candidate. Thus, concatenator 108 generates each concatenated vector by concatenating the transformed vectorial representations of the first token and of the last token of a tokenized candidate while also filtering out and excluding the transformed vectorial representations of each token enclosed by the transformed vectorial representations of the delimiter tokens.

In block 216, ESL framework 100 is capable of generating relevancies 126 for the plurality of candidates from the SQL schema based on the concatenated vectors. More particularly, a relevancy for each candidate from the SQL schema is generated by passing each corresponding concatenated vector through linear layer 110, which is capable of generating and outputting relevancies 126. Relevancies 126 provide quantitative measures of each candidate's relevancy to natural language question 124. Linear layer 110, in certain embodiments, may generate probabilities associated with each of the candidates by multiplying the concatenated vector formed from transformed vectorial representations of each candidate by a weight matrix and adding a bias vector. Each candidate's relevancy to natural language question 124 may be determined from the probabilities, the higher the probability of a candidate the greater the candidate's relevancy. In certain embodiments, the relevancy of the candidate is the probability. In some embodiments, the relevancy is determined as a logit or log probability in which relevancy is a logarithm of the odds that the candidate is relevant to the natural language question.

DOM 102, in certain embodiments, is trained with a binary cross-entropy loss function using as targets for the model a ground truth of relevant schema columns given example natural language questions. Fine tuning DOM 102 is performed iteratively, the model being revised to reduce the binary cross-entropy loss associated with the output of the model in responding to an input of training data.

In certain embodiments, the training data is created based on static analysis of the ground truth of SQL statements in selecting relevant schema columns. Initially, the static analysis identifies all SQL SELECTs. Then, for each SQL SELECT, the static analysis identifies selected columns, as well as all schema columns, determined based on SQL clauses (JOIN, WHERE, HAVING, GROUP BY, ORDER BY). The identified schema columns are columns that are relevant for a given SQL query. In some embodiments, DOM 102 is trained using the open-source MPL-2.0 SQL parser, implemented in mo-sql-parsing.

In training, as in run-time applications of ESL 100, if the determination is made that an entire SQL schema is too large given the token limit of the model, then the SQL schema is split accordingly into blocks or chunks of tables.

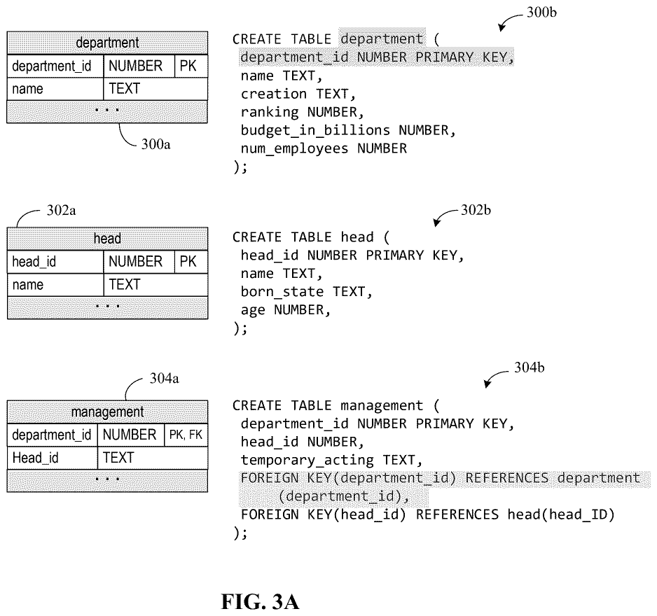

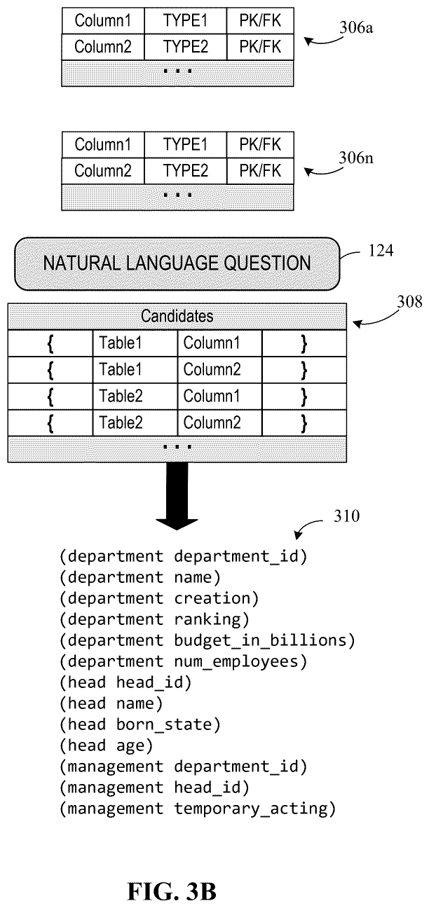

FIGS. 3A and 3B illustrate, respectively, example SQL schema 116 and related input to DOM 102 implemented in ESL framework 100. SQL schema 116 of SQL database 118 is a logical collection of database objects such as tables and table entries as well as indexes, procedures, and/or functions. The schema defines the structure and organization of the data within an SQL database. SQL schema 116, illustrated in FIG. 3A, illustratively includes tables 300a, 302a, and 304b, each table having three columns. Table 300a, 302a, and 304b may be represented as logical constructs 300b, 302b, and 304b, respectively. In FIG. 3B, SQL schema 116, including the schema columns, their types, and primary keys (PKs) and foreign keys (FKs) 306a through 306n are input to ESL framework 100 along with natural language question 124 and candidates 310. Tokenizer 106 of ESL framework 100 tokenizes the inputs for input to embedding layer 104. Tokenizer 106 of ESL framework 100 tokenizes the inputs for input to embedding layer 104. With respect to candidates 308, specifically, tokenizer 106 generates four-token strings 310 for each candidate. Each string illustratively comprises an initial delimiter token (e.g., open parenthesis), table name, corresponding column, and end delimiter token (e.g., closed parenthesis). The tokenized schema, natural language question, and candidates are input to DOM 102 for generating relevancies of each of the candidates for answering natural language question 124.

FIGS. 4A and 4B illustrate the generation of relevancies of candidates for answering a natural language question over the schema illustrated in FIG. 3A given the input of 3B, in which natural question 124 is “How many heads of departments are over 56?”

FIG. 4A illustrates the transformation by decoder block 114a-114n (FIG. 1) of vectorial representations E₁ and E₂ through E_{N} of tokens, the tokens resulting from the tokenization of the SQL schema, natural language question, and candidates generated from the input illustrated in FIG. 3B. Other inputs to the model are not shown. With respect to a tokenized candidate specifically, the vectors E₁ and E_{N} are vectorial representations of the initial delimiter token and the end delimiter token, respectively, and E₂ through E_{N-1} are vectorial representations of the string of tokens enclosed between E₁ and E_{N}. Decoder blocks 114a-114n are stacked, with each subsequent block successively transforming the output of the preceding decoder block 114. At each intermediate layer, vector transformations are generated for each of the vectorial representations E₁-E_{N} input to DOM 102. The Trm at each layer indicates a transformed vectorial representation. Although only two layers are shown, the number of layers of Trm outputs is likely much greater and coincides with the number n of decoder blocks of DOM 102. The arrows indicate that for a string of vectorial representations input to a decoder block, each vectorial representation of the string after the first one depends only on a preceding one and not a succeeding one. This illustrates the causality feature of DOM 102. The final outputs T₁ and T₂ through T_{N} are transformed vectorial representations. For each candidate, T₁ and T_{N} are the transformed vectorial representations of the candidate's initial and end delimiter tokens, respectively. Concatenator 108 concatenates the T₁ and T_{N} vectors, and the resulting concatenated vector is input to linear layer 110, which based on the input generates a relevancy corresponding to the candidate.

FIG. 4B illustrates the output of ESL 100. The relevancies 400 corresponding to each of candidates 402 is a quantitative measure of how relevant the candidate is to natural language question 124. Illustratively, the quantitative measure is a probability between zero and one and indicates a likelihood that the candidate provides the information necessary to satisfactorily answer 124 natural language question.

Referring again to FIG. 4A, ESL 100 illustratively selects one or more candidates 404 for inclusion in an SQL query for the natural language question based on quantitative relevancies 400 and inputs the selected candidate(s) into text-to-SQL pipeline 406. In certain embodiments, selected candidate(s) 404 may be the top N candidates selected by ESL framework 100 from candidates 402. Selected candidate(s) 404, in other embodiments, may be only those candidates in which the candidate's probability of relevance is greater than a predetermined threshold (e.g., 80 percent).

Text-to-SQL pipeline 406 may include an initial retrieval stage for collecting contextual knowledge such as the definition of terms and database schema elements, followed by a generation stage in which an LLM (e.g., an IBM®Granite™ AI foundation model) produces a candidate SQL query, and finally, a correction stage that regenerates the SQL as needed based on encountered errors. ESL 100 leverages the LLM and provides a quantitative measure for determining relevancies 400 of candidates 402 (the SQL schema columns) to use in generating, in response to natural language question 408, SQL query 410. Thus, text-to-SQL pipeline 406 may generate SQL query 410 based on one or more selected candidates 404, selected based on their respective relevancies to natural language question 124. The resulting SQL query will include one or more of the selected candidates, for example. SQL query 410 may be executed against SQL database 118 corresponding to SQL schema 116 previously described from which the candidates were obtained to produce a query result. ESL framework 100, for each candidate (SQL schema column), thus may generate a probability score. The higher the score, the more likely a column is relevant for answering the natural language question. By producing probability scores, ESL framework 100 influences the way in which candidates are selected or filtered by the LLM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 5, computing environment 500 contains an example of an environment for the execution of at least some of the computer code in block 550 involved in performing the inventive methods, such as ESL framework 100 implemented as executable program code or instructions. ESL framework 100 implements extractive schema linking using a decoder-only model comprising multiple decoder blocks whose output is used to generate concatenated vectors that are fed to linear layer to determine relevancies. The relevancies are a measure of how relevant each one of multiple candidates (e.g., SQL table columns) is for responding to an SQL query posed as a natural language question using text-to-SQL.

Computing environment 500 additionally includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and SCH framework 100, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

Communication fabric 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in block 550 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (e.g., where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (e.g., embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 503 is any computer system that is used and controlled by an end user (e.g., a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The terminology used herein is for the purpose of describing particular embodiments only and is not intended to be limiting. Notwithstanding, several definitions that apply throughout this document now will be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first,” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating, by computer hardware, a tokenized schema from a Structured Query Language (SQL) schema, a tokenized natural language question, and a plurality of tokenized candidates, wherein the tokenized candidates are generated by tokenizing a plurality of candidates from the SQL schema and wherein each of the plurality of tokenized candidates is formed by a string of tokens having a first token representing an initial delimiter and a last token representing an end delimiter;
generating, by the computer hardware, vectorial representations of the tokenized schema, tokenized natural language question, and each of the plurality of tokenized candidates;
generating, by the computer hardware, transformed vectorial representations by processing the vectorial representations through a decoder-only model;
generating a plurality of concatenated vectors from each of the transformed vectorial representations of the tokenized candidates, wherein each of the concatenated vectors is generated by concatenating a first transformed vectorial representation corresponding to the first token with a last transformed vectorial representation corresponding to the last token of each tokenized candidate; and
generating quantitative relevancies for the plurality of candidates from the SQL schema based on the concatenated vectors.

2. The computer-implemented method of claim 1, further comprising:
selecting one or more candidates from the plurality of candidates from the SQL schema based on the quantitative relevancies for inclusion in an SQL query for the natural language question.

3. The computer-implemented method of claim 2, further comprising:
generating the SQL query using the one or more candidates selected.

4. The computer-implemented method of claim 3, further comprising:
executing the SQL query against an SQL database corresponding to the SQL schema.

5. The computer implemented method of claim 1, further comprising:
for each tokenized candidate, selecting the first transformed vectorial representation of the candidate and the last transformed vectorial representation of the candidate and excluding each intervening transformed vectorial representation of the candidate from the concatenating.

6. The computer-implemented method of claim 1, wherein each of the plurality of candidates from the SQL schema uniquely corresponds to a column of the SQL schema.

7. The computer-implemented method of claim 1, wherein each of the plurality of candidates from the SQL schema is formed by pairing a name of an SQL table and a column of the SQL table.

8. The computer-implemented method of claim 1, wherein the decoder-only model is trained using a ground truth schema linking produced by a static analysis of a ground truth SQL statement.

9. The computer-implemented method of claim 8, wherein the static analysis identifies all SQL select columns of the SQL schema as determined by an SQL SELECT and determines all columns relevant to the ground truth SQL statement using JOIN, WHERE, HAVING, GROUP BY, ORDER statements.

10. A system, comprising:
one or more processors capable of initiating operations including:
generating a tokenized schema from a Structured Query Language (SQL) schema, a tokenized natural language question, and a plurality of tokenized candidates, wherein the tokenized candidates are generated by tokenizing a plurality of candidates from the SQL schema and wherein each of the plurality of tokenized candidates is formed by a string of tokens having a first token representing an initial delimiter and a last token representing an end delimiter;
generating vectorial representations of the tokenized schema, tokenized natural language question, and each of the plurality of tokenized candidates;
generating transformed vectorial representations by processing the vectorial representations through a decoder-only model;
generating a plurality of concatenated vectors from each of the transformed vectorial representations of the tokenized candidates, wherein each of the concatenated vectors is generated by concatenating a first transformed vectorial representation corresponding to the first token with a last transformed vectorial representation corresponding to the last token of each tokenized candidate; and
generating quantitative relevancies for the plurality of candidates from the SQL schema based on the concatenated vectors.

11. The system of claim 10, wherein the one or more processors are capable of initiating operations further including:
selecting one or more candidates from the plurality of candidates from the SQL schema based on the quantitative relevancies for inclusion in an SQL query for the natural language question.

12. The system of claim 11, wherein the one or more processors are capable of initiating operations further including:
generating the SQL query using the one or more candidates selected.

13. The system of claim 12, wherein the one or more processors are capable of initiating operations further including:
executing the SQL query against an SQL database corresponding to the SQL schema.

14. The system of claim 10, wherein the one or more processors are capable of initiating operations further including:
for each tokenized candidate, selecting the first transformed vectorial representation of the candidate and the last transformed vectorial representation of the candidate and excluding each intervening transformed vectorial representation of the candidate from the concatenating.

15. A computer program product, the computer program product comprising:
one or more computer-readable storage media and program instructions collectively stored on the one or more computer-readable storage media, the program instructions executable by a processor to cause the processor to initiate operations including:
generating a tokenized schema from a Structured Query Language (SQL) schema, a tokenized natural language question, and a plurality of tokenized candidates, wherein the tokenized candidates are generated by tokenizing a plurality of candidates from the SQL schema and wherein each of the plurality of tokenized candidates is formed by a string of tokens having a first token representing an initial delimiter and a last token representing an end delimiter;
generating vectorial representations of the tokenized schema, tokenized natural language question, and each of the plurality of tokenized candidates;
generating transformed vectorial representations by processing the vectorial representations through a decoder-only model;
generating a plurality of concatenated vectors from each of the transformed vectorial representations of the tokenized candidates, wherein each of the concatenated vectors is generated by concatenating a first transformed vectorial representation corresponding to the first token with a last transformed vectorial representation corresponding to the last token of each tokenized candidate; and
generating quantitative relevancies for the plurality of candidates from the SQL schema based on the concatenated vectors.

16. The computer program product of claim 15, wherein the program instructions are executable by the processor to cause the processor to initiate operations further including:
selecting one or more candidates from the plurality of candidates from the SQL schema based on the quantitative relevancies for inclusion in an SQL query for the natural language question.

17. The computer program product of claim 16, wherein the program instructions are executable by the processor to cause the processor to initiate operations further including:
generating the SQL query using the one or more candidates selected.

18. The computer program product of claim 17, wherein the program instructions are executable by the processor to cause the processor to initiate operations further including:
executing the SQL query against an SQL database corresponding to the SQL schema.

19. The computer program product of claim 15, wherein the program instructions are executable by the processor to cause the processor to initiate operations further including:
for each tokenized candidate, selecting the first transformed vectorial representation and the last transformed vectorial representation from three or more transformed vectorial representations for the tokenized candidate and excluding non-selected transformed vectorial representations from the concatenating.

20. The computer program product of claim 15, wherein the decoder-only model is trained using a ground truth schema linking produced by a static analysis of a ground truth SQL statement.
